(19) United States
(12) Patent Application Publication
(10) Pub. No.: US 2024/0022687 A1
(43) Pub. Date: Jan. 18, 2024

(54) NETWORK CONFERENCE CONVERGENCE SYSTEM AND METHOD

(71) Applicant: Beijing Bytedance Network Technology Co., Ltd., Beijing (CN)

(72) Inventor: Zhiye YANG, Beijing (CN)

(21) Appl. No.: 18/256,870

(22) PCT Filed: Dec. 29, 2021
(86) PCT No.: PCT/CN2021/142370

§ 371 Date: Jun. 9, 2023

(30) Foreign Application Priority Data
Jan. 21, 2021 (CN) 202110080878.0

(51) Int. Cl. H04N 7/15; H04N 7/14

(52) U.S. Cl. CPC H04N 7/157; H04N 7/152; H04N 7/147

(57) ABSTRACT

Provided are a network conference convergence system and method. The network conference convergence system includes a first client, a second client, and a cloud server. The first client is configured to create or enter a first virtual conference through a first conference application; and the cloud server is configured to join the first virtual conference through the first conference application according to a first join request. The second client is configured to create or enter a second virtual conference through a second conference application; and the cloud server is further configured to join the second virtual conference through the second conference application according to a second join request. The cloud server is further configured to create a virtual conference room according to a conference room creation request and add the first virtual conference and the second virtual conference to the virtual conference room.

This application claims priority to Chinese Patent Application No. 202110080878.0 filed with the China National Intellectual Property Administration (CNIPA) on Jan. 21, 2021, the disclosure of which is incorporated herein by reference in its entirety.

### TECHNICAL FIELD

The present disclosure relates to the field of conference convergence technologies, for example, a network conference convergence system and method.

### BACKGROUND

Many brands of network-based video conference software exist, merchants of different brands have their own independent video conference software and service systems, and video conference software of different brands generally cannot interoperate. In practical use, many enterprises use the video conference software of different brands. When a conference is held, the video conference software of different brands cannot interoperate with each other. Therefore, a counterpart's software can only be downloaded, or a telephone conference is held, which brings a lot of inconvenience. Therefore, a video conference between different conference products has become a communication obstacle and has two major problems: the video conference software is independent of each other, and the different video conference software cannot interconnect and interoperate; and when users using the different video conference software hold a conference with each other, the users cannot quickly access each other's video conference software and can only download the counterpart's software, which causes inconvenience to the users.

### SUMMARY

The present disclosure provides a network conference convergence system and method, which can implement the interconnection and interoperation between different conference software. Thus, when users using different video conference software hold a conference with each other, the users quickly access each other's video conference software so that the convenience of a network conference is improved for the users.

The present disclosure provides a network conference convergence system including a first client, a second client, and a cloud server.

The first client is installed with a first conference application and a cloud conference application, the second client is installed with a second conference application and the cloud conference application, and the cloud server is installed with the first conference application and the second conference application.

The first client is configured to create or enter a first virtual conference through the first conference application and send a first join request to the cloud server through the cloud conference application; and the cloud server is configured to join the first virtual conference through the first conference application according to the first join request.

The second client is configured to create or enter a second virtual conference through the second conference application and send a second join request to the cloud server through the cloud conference application; and the cloud server is further configured to join the second virtual conference through the second conference application according to the second join request.

The cloud server is further configured to receive a conference room creation request sent by the first client or the second client, create a virtual conference room according to the conference room creation request, and add the first virtual conference and the second virtual conference to the virtual conference room.

The first client and the second client are further configured to transmit data through the virtual conference room.

The present disclosure further provides a network conference convergence system including a first client, a second client, and a cloud server.

The first client is installed with a first conference application and a cloud conference application, the second client is installed with the cloud conference application, and the cloud server is installed with the first conference application.

The first client is configured to create or enter a first virtual conference through the first conference application and send a first join request to the cloud server through the cloud conference application; and the cloud server is configured to join the first virtual conference through the first conference application according to the first join request.

The second client is configured to join the first virtual conference through the cloud conference application.

The first client and the second client are further configured to transmit data through the cloud server.

The present disclosure further provides a network conference convergence method performed by the network conference convergence system according to embodiments of the present disclosure.

The method includes the steps described below.

Based on a first client, a first virtual conference is created or entered through a first conference application and a first join request is sent to a cloud server through a cloud conference application.

Based on a second client, a second virtual conference is created or entered through a second conference application and a second join request is sent to the cloud server through the cloud conference application.

The first virtual conference is joined through the first conference application by the cloud server according to the first join request, and the second virtual conference is joined through the second conference application according to the second join request.

A conference room creation request sent by the first client or the second client is received by the cloud server, a virtual conference room is created according to the conference room creation request, and the first virtual conference and the second virtual conference are added to the virtual conference room, so that the first client and the second client transmit data through the virtual conference room.

The present disclosure discloses a network conference convergence method performed by the network conference convergence system according to embodiments of the present disclosure. The method includes the steps described below.

A first virtual conference is created or entered by a first client through a first conference application and a first join request is sent to a cloud server through a cloud conference application.

The first virtual conference is joined through the first conference application by the cloud server according to the first join request.

The first virtual conference is joined through the cloud conference application by a second client.

The first client and the second client transmit data through the cloud server.

### BRIEF DESCRIPTION OF DRAWINGS

FIG. 1 is a structural diagram of a network conference convergence system according to an embodiment of the present disclosure;

FIG. 2 is a structural diagram of another network conference convergence system according to an embodiment of the present disclosure;

FIG. 3 is a structural diagram of another network conference convergence system according to an embodiment of the present disclosure;

FIG. 4 is a structural diagram of another network conference convergence system according to an embodiment of the present disclosure;

FIG. 5 is a flowchart of a network conference convergence method according to an embodiment of the present disclosure;

FIG. 6 is a flowchart of another network conference convergence method according to an embodiment of the present disclosure; and

FIG. 7 is a schematic diagram showing a data interaction process of a first virtual conference and a second virtual conference according to an embodiment of the present disclosure.

### DETAILED DESCRIPTION

Embodiments of the present disclosure are described hereinafter with reference to the drawings.

The drawings illustrate some embodiments of the present disclosure, but the present disclosure may be implemented in various manners and should not be construed as limited to the embodiments set forth herein. These embodiments are provided for ease of understanding of the present disclosure. The drawings and embodiments of the present disclosure are illustrative.

Steps described in method embodiments of the present disclosure may be performed in sequence and/or in parallel. Additionally, the method embodiments may include additional steps and/or omit some of the illustrated steps. The scope of the present disclosure is not limited in this respect.

The term “include” and variations thereof used herein refer to “including, but not limited to”. The term “based on” refers to “at least partially based on”. The term “an embodiment” refers to “at least one embodiment”. The term “another embodiment” refers to “at least one another embodiment”. The term “some embodiments” refers to “at least some embodiments”. Definitions of other terms are given in the description hereinafter.

Concepts such as “first” and “second” in the present disclosure are used to distinguish between apparatuses, between modules, or between units and are not intended to limit the order or mutual dependence of the functions performed by these apparatuses, modules, or units.

Modifications “one” and “multiple” mentioned in the present disclosure are illustrative instead of restrictive and should be construed as “one or more” by those skilled in the art, unless otherwise indicated in the context.

The names of messages or information exchanged between apparatuses in the implementations of the present disclosure are only used for illustrative purposes and are not intended to limit the scope of the messages or information.

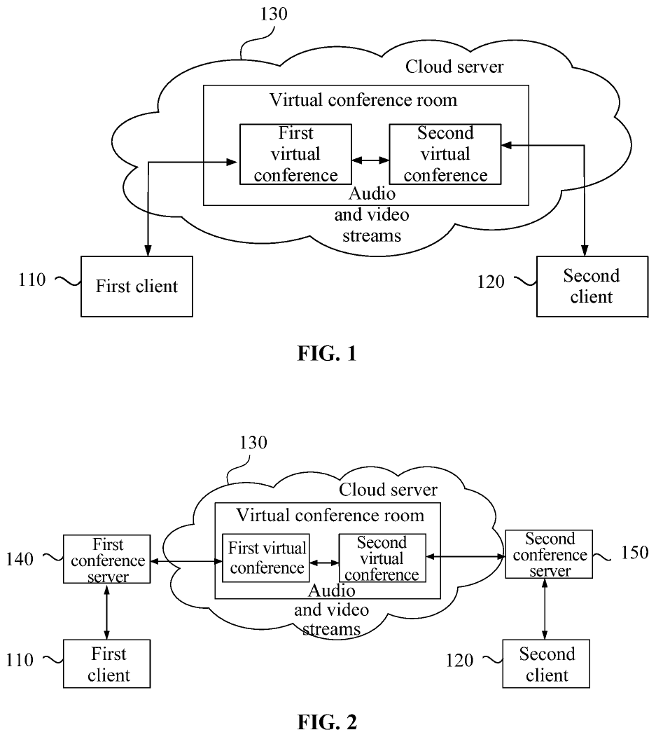

FIG. 1 is a structural diagram of a network conference convergence system according to an embodiment of the present disclosure. As shown in FIG. 1, the system includes a first client 110, a second client 120, and a cloud server 130.

The first client 110 is installed with a first conference application and a cloud conference application. The second client 120 is installed with a second conference application and the cloud conference application. The cloud server 130 is installed with the first conference application and the second conference application.

The first client 110 creates or enters a first virtual conference through the first conference application. The first client 110 sends a first join request to the cloud server 130 through the cloud conference application. The cloud server 130 joins the first virtual conference through the first conference application according to the first join request.

The second client 120 creates or enters a second virtual conference through the second conference application. The second client 120 sends a second join request to the cloud server 130 through the cloud conference application. The cloud server 130 joins the second virtual conference through the second conference application according to the second join request.

The cloud server 130 receives a conference room creation request sent by the first client 110 or the second client 120, creates a virtual conference room according to the conference room creation request, and adds the first virtual conference and the second virtual conference to the virtual conference room. The first client 110 and the second client 120 transmit data through the virtual conference room.

The first conference application and the second conference application may be understood as applications developed by different developers to implement network conferences. Multiple first clients 110 and multiple second clients 120 may exist. In this embodiment, conference applications are not limited to two kinds of conference applications developed by the developers.

Multiple conference applications may be included, or a conference application may be understood as any conference application which may be suitable for appearing on the market currently. For example, the system may further include a third client and a fourth client, where the third client is installed with a third conference application, and the fourth client is installed with a fourth conference application.

The cloud conference application may be implemented through any one of a web page, a software plug-in, a script, or an application. Authentication may be implemented by the cloud conference application through a login or the like.

The first join request may be a first conference number, and the second join request may be a second conference number. After creating or entering the first virtual conference through the first conference application, the first client 110 sends the first conference number to the cloud server 130 through the cloud conference application, and the cloud server 130 joins the first virtual conference through the first conference application according to the first conference number.

After creating or entering the second virtual conference through the second conference application, the second client 120 sends the second conference number to the cloud server 130 through the cloud conference application, and the cloud server 130 joins the second virtual conference through the second conference application according to the second conference number.

The first client 110 or the second client 120 may send the conference room creation request to the cloud server 130. The cloud server 130 creates the virtual conference room according to the conference room creation request and adds the first virtual conference and the second virtual conference to the virtual conference room.

In this embodiment, the process in which the first client 110 and the second client 120 transmit the data through the virtual conference room may be as follows: the first client 110 sends a first video stream and a first audio stream which are acquired to the first virtual conference of the cloud server 130; the first video stream and the first audio stream are forwarded by the first virtual conference to the second virtual conference; and the first video stream and the first audio stream are sent by the second virtual conference to the second client 120. The second client 120 sends a second video stream and a second audio stream which are acquired to the second virtual conference of the cloud server 130, the second video stream and the second audio stream are forwarded by the second virtual conference to the first virtual conference, and the second video stream and the second audio stream are sent by the first virtual conference to the first client 110.

The first virtual conference sends the first video stream to the second virtual conference through a virtual camera channel and forwards the first audio stream to the second virtual conference through a virtual microphone channel. The second virtual conference sends the second video stream to the first virtual conference through the virtual camera channel and forwards the second audio stream to the first virtual conference through the virtual microphone channel.

For example, FIG. 7 is a schematic diagram showing a data interaction process of a first virtual conference and a second virtual conference according to an embodiment of the present disclosure.

As shown in FIG. 7, a virtual speaker, a virtual microphone, a virtual camera, and a virtual screen recording module are established by the first virtual conference; and a virtual speaker, a virtual microphone, a virtual camera, and a virtual screen recording module are established by the second virtual conference. The first video stream and the first audio stream are used as examples. When the first virtual conference in the cloud server receives the first video stream and the first audio stream, the first audio stream is sent to the virtual microphone of the second virtual conference through the virtual speaker, and the first video stream is virtually played by the virtual screen recording module such that the virtual camera of the second virtual conference acquires the first video stream.

Optionally, as shown in FIG. 2, the system further includes a first conference server 140 and a second conference server 150.

The first client 110 sends the first video stream and the first audio stream which are acquired to the first virtual conference of the cloud server 130 through the first conference server 140; and the second video stream and the second audio stream are sent by the first virtual conference to the first client 110 through the first conference server 140.

The second client 120 sends the second video stream and the second audio stream which are acquired to the second virtual conference of the cloud server 130 through the second conference server 150; and the first video stream and the first audio stream are sent by the second virtual conference to the second client 120 through the second conference server 150.

If the multiple first clients 110 exist, the first conference server 140 distributes the second video stream and the second audio stream to the multiple first clients 110. Similarly, if the multiple second clients 120 exist, the second conference server 150 distributes the first video stream and the first audio stream to the multiple second clients 120.

In this embodiment, for a client installed with the first conference application, the first virtual conference may be joined by the client through the first conference application. For a client installed with the second conference application, the second virtual conference may be joined by the client through the second conference application.

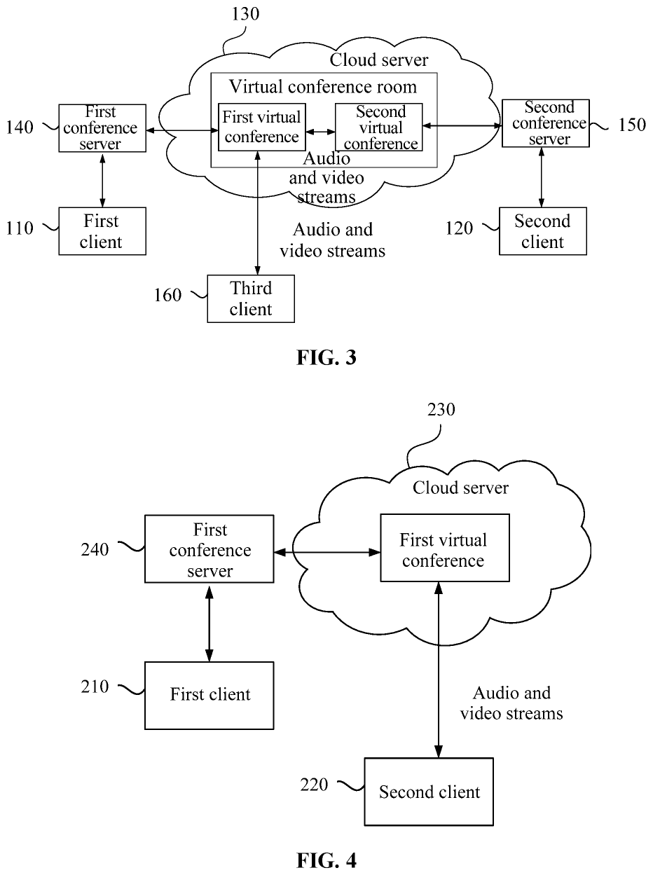

Optionally, as shown in FIG. 3, the system further includes a third client 160 installed with the cloud conference application. The third client 160 joins the first virtual conference or the second virtual conference through the cloud conference application. The first client 110, the second client 120, and the third client 160 transmit the data through the virtual conference room. In this solution, only one cloud conference application needs to be installed on the third client 160 such that the third client 160 can establish conference interoperation with a client on which another conference application is installed.

Multiple third clients 160 may exist. In this embodiment, if the third client 160 joins the first virtual conference, the process in which the first client 110, the second client 120, and the third client 160 transmit the data through the virtual conference room may be as follows: the third client 160 may send a third video stream and a third audio stream which are acquired to the first virtual conference in the cloud server 130. The third video stream and the third audio stream are sent by the first virtual conference to the first client 110 through the first conference server 140. The third video stream and the third audio stream are forwarded by the first virtual conference to the second virtual conference, and the third video stream and the third audio stream are sent by the second virtual conference to the second client 120 through the second conference server 150.

For the first video stream and the first audio stream from the first client 110, the first video stream and the first audio stream are directly sent by the first virtual conference to the third client 160.

For the second video stream and the second audio stream from the second client 120, the second video stream and the second audio stream are directly sent by the first virtual conference to the third client 160.

If the third client joins the second virtual conference, the process in which the first client 110, the second client 120, and the third client 160 transmit the data through the virtual conference room is similar to that described above, and the details are not repeated here.

The network conference convergence system provided in the embodiment of the present disclosure includes the first client, the second client, and the cloud server. The first client is installed with the first conference application and the cloud conference application, the second client is installed with the second conference application and the cloud conference application, and the cloud server is installed with the first conference application and the second conference application. The first client creates or enters the first virtual conference through the first conference application, the first client sends the first join request to the cloud server through the cloud conference application, and the cloud server joins the first virtual conference through the first conference application according to the first join request. The second client creates or enters the second virtual conference through the second conference application, the second client sends the second join request to the cloud server through the cloud conference application, and the cloud server joins the second virtual conference through the second conference application according to the second join request. The cloud server receives the conference room creation request sent by the first client or the second client, creates the virtual conference room according to the conference room creation request, and adds the first virtual conference and the second virtual conference to the virtual conference room. The first client and the second client transmit the data through the virtual conference room. In the network conference convergence system provided in the embodiment of the present disclosure, the virtual conference room is created on the cloud server, and the first virtual conference and the second virtual conference are added to the virtual conference room so that the data transmission between the first client and the second client is implemented, which can implement the interconnection and interoperation between different conference software. Thus, when users using different video conference software hold a conference with each other, the users quickly access each other's video conference software so that the convenience of a network conference is improved for the users.

FIG. 4 is a structural diagram of another network conference convergence system according to an embodiment of the present disclosure. As shown in FIG. 4, the system includes a first client 210, a second client 220, and a cloud server 230.

The first client 210 is installed with a first conference application and a cloud conference application. The second client 220 is installed with the cloud conference application. The cloud server 230 is installed with the first conference application.

The first client 210 creates or enters a first virtual conference through the first conference application; and the first client 210 sends a first join request to the cloud server 230 through the cloud conference application. The cloud server 230 joins the first virtual conference through the first conference application according to the first join request.

The second client 220 joins the first virtual conference through the cloud conference application.

The first client 210 and the second client 220 transmit data through the cloud server.

Multiple first clients 210 and multiple second clients 220 may exist. In this embodiment, the process in which the first client 210 and the second client 220 transmit the data through the cloud server may be as follows: the first client 210 sends a first video stream and a first audio stream which are acquired to the cloud server 230, and the cloud server 230 sends the first video stream and the first audio stream to the second client 22. The second client 220 sends a second video stream and a second audio stream which are acquired to the cloud server, and the cloud server 230 sends the second video stream and the second audio stream to the first client 210.

Optionally, as shown in FIG. 4, the system further includes a first conference server 240, and the first client 210 sends the first video stream and the first audio stream which are acquired to the cloud server 230 through the first conference server 240. The cloud server 230 sends the second video stream and the second audio stream to the first client 210 through the first conference server 240.

The network conference convergence system provided in the embodiment of the present disclosure includes the first client, the second client, and the cloud server. The first client is installed with the first conference application and the cloud conference application. The second client is installed with the cloud conference application. The cloud server is installed with the first conference application. The first client creates or enters the first virtual conference through the first conference application. The first client sends the first join request to the cloud server through the cloud conference application. The cloud server joins the first virtual conference through the first conference application according to the first join request. The second client joins the first virtual conference through the cloud conference application. The first client and the second client transmit the data through the cloud server. The second client implements conference interoperation with the first client through the installation of the cloud conference application so that the data transmission between the first client and the second client is implemented, which can implement the interconnection and interoperation between different conference software.

Thus, when users using different video conference software hold a conference with each other, the users quickly access each other's video conference software so that the convenience of a network conference is improved for the users.

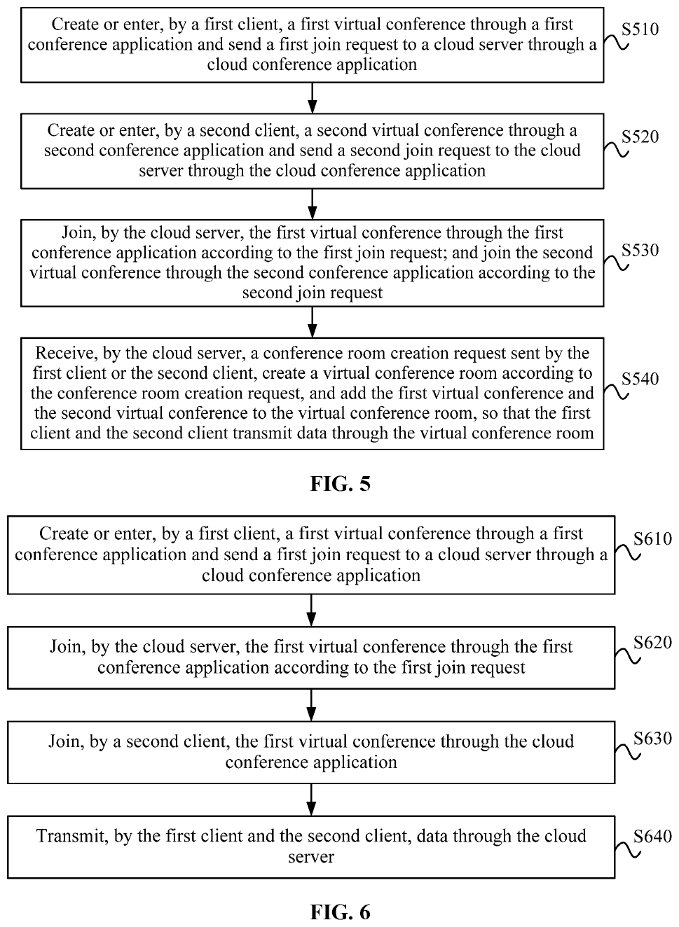

FIG. 5 is a flowchart of a network conference convergence method according to an embodiment of the present disclosure. The method is performed by the network conference convergence system described in the preceding embodiment. As shown in FIG. 5, the method includes the steps described below.

In step 510, a first virtual conference is created or entered through a first conference application by a first client and a first join request is sent to a cloud server through a cloud conference application.

In step 520, a second virtual conference is created or entered through a second conference application by a second client and a second join request is sent to the cloud server through the cloud conference application.

In step 530, the first virtual conference is joined through the first conference application by the cloud server according to the first join request; and the second virtual conference is joined through the second conference application by the cloud server according to the second join request.

In step 540, a conference room creation request sent by the first client or the second client is received by the cloud server, a virtual conference room is created according to the conference room creation request, and the first virtual conference and the second virtual conference are added to the virtual conference room, so that the first client and the second client transmit data through the virtual conference room.

Optionally, the process in which the first client and the second client transmit the data through the virtual conference room may be as follows: the first client sends a first video stream and a first audio stream which are acquired to the first virtual conference of the cloud server through a first conference server; the first video stream is sent by the first virtual conference to the second virtual conference through a virtual camera channel, and the first audio stream is forwarded by the first virtual conference to the second virtual conference through a virtual microphone channel; and the first video stream and the first audio stream are sent by the second virtual conference to the second client through a second conference server.

The second client sends a second video stream and a second audio stream which are acquired to the second virtual conference of the cloud server through a second conference server, the second video stream is sent by the second virtual conference to the first virtual conference through the virtual camera channel, and the second audio stream is forwarded by the second virtual conference to the first virtual conference through the virtual microphone channel; and the second video stream and the second audio stream are sent by the first virtual conference to the first client through the first conference server.

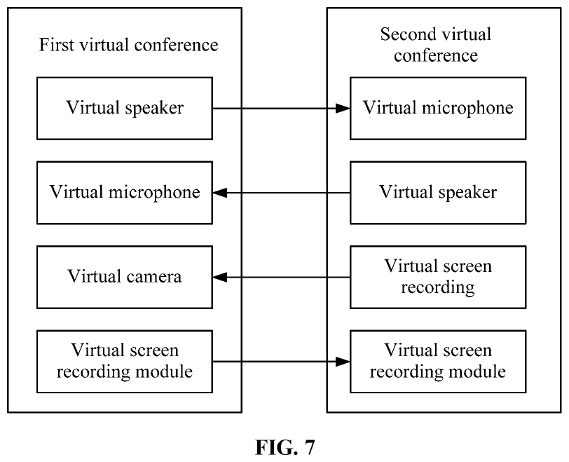

FIG. 6 is a flowchart of another network conference convergence method according to an embodiment of the present disclosure. The method is performed by the network conference convergence system described in the preceding embodiment. As shown in FIG. 6, the method includes the steps described below.

In step 610, a first virtual conference is created or entered through a first conference application by a first client and a first join request is sent to a cloud server through a cloud conference application.

In step 620, the first virtual conference is joined through the first conference application by the cloud server according to the first join request.

In step 630, the first virtual conference is joined through the cloud conference application by a second client.

In step 640, the first client and the second client transmit data through the cloud server.

The process in which the first client and the second client transmit the data through the cloud server may be as follows: the first client sends a first video stream and a first audio stream which are acquired to the cloud server through a first conference server; and the cloud server sends the first video stream and the first audio stream to the second client.

The second client sends a second video stream and a second audio stream which are acquired to the cloud server; and the cloud server sends the second video stream and the second audio stream to the first client through the first conference server.

1. A network conference convergence system, comprising: a first client, a second client, and a cloud server;
wherein the first client is installed with a first conference application and a cloud conference application, the second client is installed with a second conference application and the cloud conference application, and the cloud server is installed with the first conference application and the second conference application;
wherein the first client is configured to create or enter a first virtual conference through the first conference application and send a first join request to the cloud server through the cloud conference application, and the cloud server is configured to join the first virtual conference through the first conference application according to the first join request;
wherein the second client is configured to create or enter a second virtual conference through the second conference application and send a second join request to the cloud server through the cloud conference application, and the cloud server is further configured to join the second virtual conference through the second conference application according to the second join request;
wherein the cloud server is further configured to receive a conference room creation request sent by the first client or the second client, create a virtual conference room according to the conference room creation request, and add the first virtual conference and the second virtual conference to the virtual conference room; and
wherein the first client and the second client are further configured to transmit data through the virtual conference room.

2. The system according to claim 1, wherein the first client and the second client are configured to transmit the data through the virtual conference room in a following manner:
the first client is configured to send a first video stream and a first audio stream which are acquired to the first virtual conference of the cloud server, the first virtual conference is used for forwarding the first video stream and the first audio stream to the second virtual conference, and the second virtual conference is used for sending the first video stream and the first audio stream to the second client; and
the second client is configured to send a second video stream and a second audio stream which are acquired to the second virtual conference of the cloud server, the second virtual conference is further used for forwarding the second video stream and the second audio stream to the first virtual conference, and the first virtual conference is also used for sending the second video stream and the second audio stream to the first client.

3. The system according to claim 2, wherein the first virtual conference is used for sending the first video stream to the second virtual conference through a virtual camera channel and forwarding the first audio stream to the second virtual conference through a virtual microphone channel; and
wherein the second virtual conference is used for sending the second video stream to the first virtual conference through the virtual camera channel and forwarding the second audio stream to the first virtual conference through the virtual microphone channel.

4. The system according to claim 2, further comprising: a first conference server and a second conference server;
wherein the first client and the second client are configured to transmit the data through the virtual conference room in a following manner:
the first client is configured to send the first video stream and first audio stream which are acquired to the first virtual conference of the cloud server through the first conference server, and the first virtual conference is used for sending, through the first conference server, the second video stream and the second audio stream acquired by the second client to the first client; and
the second client is configured to send the second video stream and the second audio stream which are acquired to the second virtual conference of the cloud server through the second conference server, and the second virtual conference is used for sending the first video stream and the first audio stream to the second client through the second conference server.

5. The system according to claim 1, further comprising: a third client installed with the cloud conference application;
wherein the third client is configured to join the first virtual conference or the second virtual conference through the cloud conference application; and
wherein the first client, the second client, and the third client are further configured to transmit the data through the virtual conference room.

6. The system according to claim 1, wherein the cloud conference application is implemented through one of a web page, a software plug-in, a script, or an application.

7. A network conference convergence system, comprising: a first client, a second client, and a cloud server;
wherein the first client is installed with a first conference application and a cloud conference application, the second client is installed with the cloud conference application, and the cloud server is installed with the first conference application;
wherein the first client is configured to create or enter a first virtual conference through the first conference application and send a first join request to the cloud server through the cloud conference application; and the cloud server is configured to join the first virtual conference through the first conference application according to the first join request;
the second client is configured to join the first virtual conference through the cloud conference application; and
the first client and the second client are further configured to transmit data through the cloud server.

8. The system according to claim 7, wherein the first client and the second client are configured to transmit the data through the cloud server in a following manner:
the first client is configured to send a first video stream and a first audio stream which are acquired to the cloud server, and the cloud server is configured to send the first video stream and the first audio stream to the second client; and
the second client is configured to send a second video stream and a second audio stream which are acquired to the cloud server, and the cloud server is further configured to send the second video stream and the second audio stream to the first client.

9. A network conference convergence method performed by the system according to claim 1, comprising:
creating or entering, by a first client, a first virtual conference through a first conference application and sending a first join request to a cloud server through a cloud conference application;
creating or entering, by a second client, a second virtual conference through a second conference application and sending a second join request to the cloud server through the cloud conference application;
joining, by the cloud server, the first virtual conference through the first conference application according to the first join request; and joining the second virtual conference through the second conference application according to the second join request; and
receiving, by the cloud server, a conference room creation request sent by the first client or the second client, creating a virtual conference room according to the conference room creation request, and adding the first virtual conference and the second virtual conference to the virtual conference room, so that the first client and the second client transmit data through the virtual conference room.

10. A network conference convergence method performed by the system according to claim 7, comprising:
creating or entering, by a first client, a first virtual conference through a first conference application and sending a first join request to a cloud server through a cloud conference application;
joining, by the cloud server, the first virtual conference through the first conference application according to the first join request;
joining, by a second client, the first virtual conference through the cloud conference application; and
transmitting, by the first client and the second client, data through the cloud server.

11. The network conference convergence method according to claim 9, wherein transmitting, by the first client and the second client, the data through the virtual conference room comprises:
sending, by the first client, a first video stream and a first audio stream which are acquired to the first virtual conference of the cloud server through a first conference server, wherein the first video stream is sent by the first virtual conference to the second virtual conference through a virtual camera channel, and the first audio stream is forwarded by the first virtual conference to the second virtual conference through a virtual microphone channel; and
sending, the second virtual conference, the first video stream and the first audio stream to the second client through a second conference server.

12. The network conference convergence method according to claim 9, wherein transmitting, by the first client and the second client, the data through the virtual conference room comprises:
sending, by the second client, a second video stream and a second audio stream which are acquired to the second virtual conference of the cloud server through a second conference server, wherein the second video stream is sent by the second virtual conference to the first virtual conference through the virtual camera channel, and the second audio stream is forwarded by the second virtual conference to the first virtual conference through the virtual microphone channel; and
sending, the second virtual conference, the second video stream and the second audio stream to the first client through the first conference server.

13. The network conference convergence method according to claim 10, wherein transmitting, by the first client and the second client, the data through the cloud server comprises:
sending, by the first client, a first video stream and a first audio stream which are acquired to the cloud server through a first conference server; and
sending, by the cloud server, the first video stream and the first audio stream to the second client.

14. The network conference convergence method according to claim 10, wherein transmitting, by the first client and the second client, the data through the cloud server comprises:
sending, by the first client, a first video stream and a first audio stream which are acquired to the cloud server through a first conference server; and
sending, by the cloud server, the first video stream and the first audio stream to the second client.
